(19) United States
(12) Patent Application Publication
(10) Pub. No.: US 2017/0161274 A1
(43) Pub. Date: Jun. 8, 2017

(54) APPARATUS AND METHOD FOR PROVIDING CONTENT INFORMATION IN COMMUNICATION SYSTEM

(71) Applicant: SAMSUNG ELECTRONICS CO., LTD., Suwon-si (KR)

(72) Inventors: Nu-El CHOI, Seongnam-si (KR); Haeng-Youl SHIN, Suwon-si (KR); Hoon-Jae LEE, Suwon-si (KR); Bo-Seong SEO, Suwon-si (KR); Won-Hee LEE, Suwon-si (KR)

(21) Appl. No.: 15/371,901

(22) Filed: Dec. 7, 2016

(30) Foreign Application Priority Data
Dec. 7, 2015 (KR) 10-2015-0173155

(51) Int. Cl. G06F 17/30

(52) U.S. Cl. CPC G06F 17/30038; G06F 17/30058; G06F 17/30873; G06F 17/3005

(57) ABSTRACT

In accordance with an example aspect of the present disclosure, a method for providing content information in a communication system is provided. The method includes obtaining consumption information relating to consumption of content; recording the consumption information in a recording area of the content to manage the content; and outputting the content and the consumption information if a request event to request the content is detected.

### CROSS-REFERENCE TO RELATED APPLICATION

This application is based on and claims priority under 35 U.S.C. §119 to Korean Patent Application No. 10-2015-0173155, filed on Dec. 7, 2015 in the Korean Intellectual Property Office, the disclosure of which is incorporated by reference herein in its entirety.

### TECHNICAL FIELD

The present disclosure relates generally to an apparatus and method for providing information about content in a terminal of a communication system.

### BACKGROUND

The Internet is evolving from a human-centered connectivity network where humans generate and consume information to an Internet of Things (IoT) network where distributed things send, receive and process information between them without human intervention. Internet of Everything (IoE) technology may be an example of a combination of the IoT technology and a big data processing technology through connection with a cloud server.

To implement IoT, various technologies, such as sensing technology, wired/wireless communication and network infrastructure, service interfacing technology, and security technology are required, and recently, even technologies for sensor network, Machine to Machine (M2M), Machine Type Communication (MTC) for connection between things are being studied.

Such an IoT environment may provide intelligent Internet Technology (IT) services that create a new value to human life by collecting and analyzing data generated among connected things. IoT may be applied to a variety of areas including smart home, smart building, smart city, smart car or connected car, smart grid, health care, smart home appliances and advanced medical services through convergence and combination between existing IT technologies and various industrial applications.

With the wide spread of personal terminals, such as computers and smart devices these days, most users each have one or more personal terminals. In the current situations where all the users have their own personal terminals, the users use the terminal to conveniently create content (e.g., images, audio, video, etc.), consume and share the content through various channels.

However, conventional terminals only manage basic information about content itself and creation of the content, but do not manage information about consumption and sharing of the content. Since the terminals do not mange information about consumption and sharing of the content, information about consumption or use of the content may not be provided and distribution channels and the first source of the content may not be checked out. Furthermore, the terminals cannot check out an application or website that previously consumed particular content, they are not able to access an object that consumed the particular content (e.g., a social network site (SNS) to which the content was uploaded) or may not perform the same consumption operation. Moreover, users of the terminals mainly select and consume particular preferred content rather than consuming all a lot of content. The conventional terminals, however, may not check out which content was mostly consumed among numerous content, so it is difficult to tell content preferred by the user from others.

The above information is presented as background information only to assist with an understanding of the present disclosure.

### SUMMARY

The present disclosure provides an apparatus and method for providing consumption information about content in a communication system.

The present disclosure also provides an apparatus and method for providing consumption information about content by recording the consumption information in a recording area to manage content in a communication system.

In accordance with an example aspect of the present disclosure, a method for providing content information in a communication system is provided. The method includes obtaining consumption information relating to consumption of content; recording the consumption information in a recording area to manage the content; and outputting the content and the consumption information if a request event to request the content is detected.

In accordance with another example aspect of the present disclosure, an apparatus for providing content information in a communication system is provided. The apparatus includes a controller configured to obtain consumption information relating to consumption of content, to record the consumption information in a recording area to manage the content, and to output the content and the consumption information if a request event to request the content is detected; and an output unit comprising output circuitry configured to output the content and the consumption information.

### BRIEF DESCRIPTION OF THE DRAWINGS

The above and other objects, features and advantages of the present disclosure will become more readily apparent to those of ordinary skill in the art from the following detailed description, taken in conjunction with the accompanying drawings, in which like reference numerals refer to like elements, and wherein:

FIG. 1 is a block diagram illustrating an example apparatus for providing consumption information about content in a terminal of a communication system, according to an example embodiment of the present disclosure;

FIG. 2 is a block diagram illustrating an example control unit 110 in a terminal, according to an example embodiment of the present disclosure;

FIG. 3 is a flowchart illustrating an example method for obtaining and collecting consumption information of an image in an obtainer 111 included in the control unit 110, according to an embodiment of the present disclosure;

FIGS. 4 and 5 are diagrams illustrating examples of how a recorder 113 included in the control unit 110 records consumption information in a recording area to manage an image, according to example embodiments of the present disclosure;

FIGS. 6A, 6B, 6C and 6D are diagrams illustrating an example of outputting image and consumption information in an output unit 153, according to an example embodiment of the present disclosure;

FIG. 7 is a flowchart illustrating an example method for providing consumption information about content in a terminal of a communication system, according to an example embodiment of the present disclosure; and

FIGS. 8A, 8B and 8C are diagrams illustrating an example of utilizing consumption details included in consumption information in a terminal 100, according to an example embodiment of the present disclosure.

Throughout the drawings, like reference numerals will be understood to refer to like parts, components, and structures.

### DETAILED DESCRIPTION

Reference will now be made in greater detail to various example embodiments, examples of which are illustrated in the accompanying drawings, wherein like reference numerals refer to the like elements throughout. Descriptions of some well-known technologies that possibly obscure the invention may be omitted, if necessary.

In various example embodiments of the present disclosure, a terminal in a communication system may be configured to collect and obtain consumption information about content consumed by each application, and provide the obtained consumption information if the content is selected. The content herein used may refer, for example, and without limitation, to images, audio, video, etc.

In example embodiments of the present disclosure, the user may use a terminal to not only simply view an image but also understand a flow of consumption of the image in various ways, such as sharing the image through an application, such as a Social Networking Site (SNS), a messenger, and an email, uploading the image to a website, sharing the image with other terminals, etc., and easily access the past consumption details.

For this, an apparatus and method for providing consumption information about content in a terminal of a communication system in accordance with example embodiments of the present disclosure will now be described in greater detail.

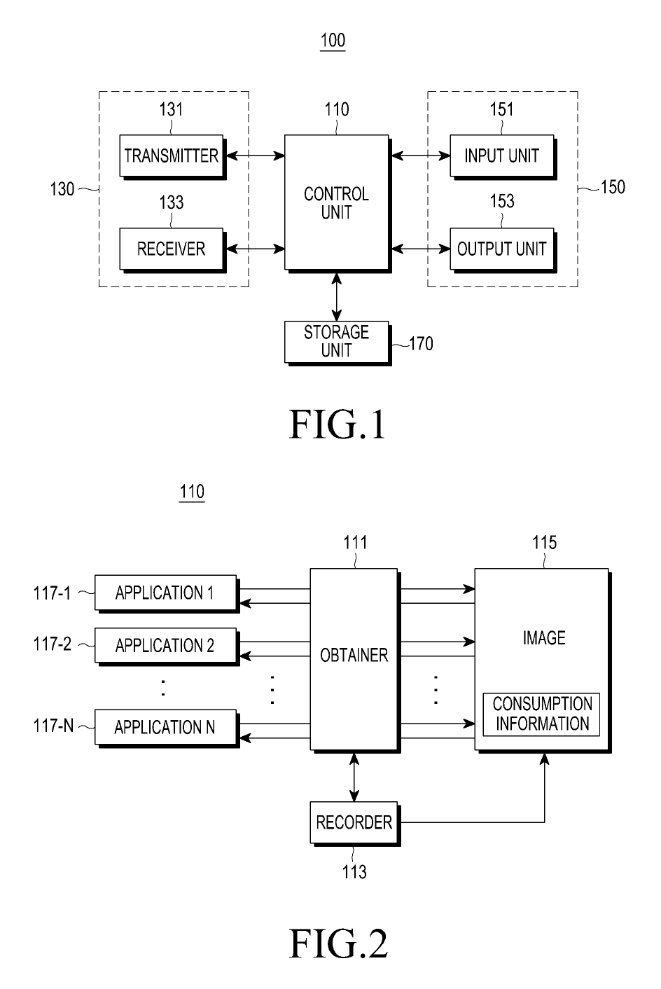

FIG. 1 is a block diagram illustrating an example apparatus for providing consumption information about content in a terminal of a communication system, according to an example embodiment of the present disclosure.

Referring to FIG. 1, a terminal 100 may include a control unit (e.g., including processing circuitry and program modules) 110, a transmitter 131, a receiver 133, an input unit (e.g., including input circuitry) 151, an output unit (e.g., including output circuitry) 153, and a storage unit 170. In various example configurations of the terminal 100, the transmitter 131 and the receiver 133 may be included in a transceiver 130, and the input unit 151 and the output unit 153 may be included in an input/output unit 150.

The control unit 110 may include various processing circuitry configured to control general operation of the terminal 100, and to control operation related to providing consumption information about content performed in the communication system. The operation of providing consumption information about content performed in the communication system in accordance with an example embodiment of the present disclosure will be described in greater detail below in connection with FIGS. 2 to 6.

The transmitter 131 may include various circuitry configured to transmit various signals and messages to other entities, e.g., a broadcasting device, a wireless node, a gateway, and a server included in the communication system under the control of the control unit 110. The transmitter 131 may transmit a message requesting an application to a server for providing a corresponding application.

Furthermore, the receiver 133 may include various circuitry configured to receive various signals and messages from other entities, e.g., a broadcasting device, a wireless node, a gateway, and a server included in the communication system under the control of the control unit 110. The receiver 133 may receive the requested application from a server.

The storage unit 170 may store a program and consumption information relating to the operation of providing consumption information about content performed in the communication system in accordance with an example embodiment of the present disclosure under the control of the control unit 110. Furthermore, the storage unit 170 may store various signals and messages received by the receiver 133 from other entities.

The input unit 151 and the output unit 153 may respectively include various circuitry configured to respectively input and output various signals and messages related to the operation of providing consumption information about content performed by the terminal 100 in the communication system in accordance with an example embodiment of the present disclosure under the control of the control unit 110. The input unit 151 may receive an event of approaching at least one of a plurality of contents, and the output unit 153 may output the content and consumption information about the content.

While FIG. 1 shows that the transmitter 131, the receiver 133, the control unit 110, the input unit 151, the output unit 153, and the storage unit 170 are separately implemented, the terminal 100 may be implemented in a form in which at least two of the transmitter 131, the receiver 133, the control unit 110, the input unit 151, the output unit 153, and the storage unit 170 are integrated together. Furthermore, the terminal 100 may also be implemented in a single processor.

FIG. 2 is a block diagram illustrating the example control unit 110 in a terminal, according to an example embodiment of the present disclosure.

In the following example embodiment, content is assumed to be an image (or images) as an example. However, the example embodiment of the present disclosure may also be applied to not only the image but also a multimedia type file, such as audio and video, or the like.

Referring to FIG. 2, the control unit 110 includes various processing circuitry including, for example, an obtainer 111 and a recorder 113. It will be understood that the obtainer 111 and the recorder 113 may be implemented in hardware (e.g., circuitry), software (e.g., a programming module or application), firmware, or any combination thereof.

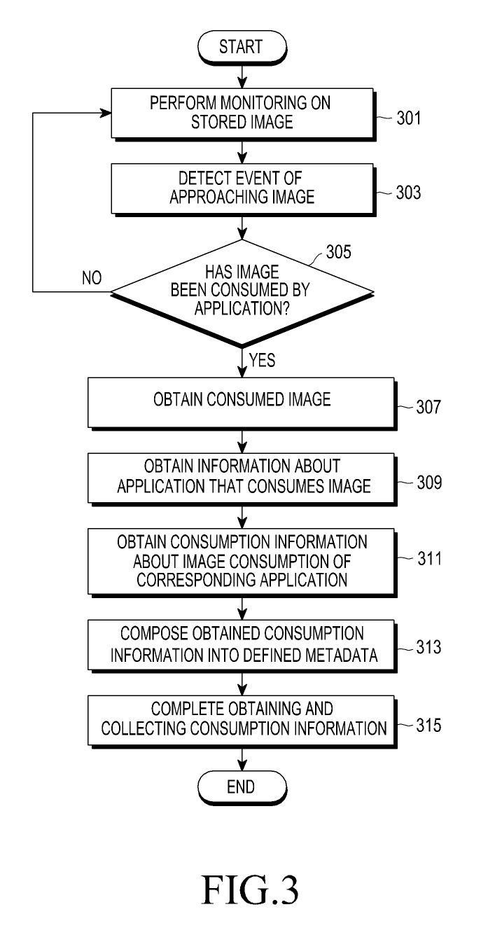

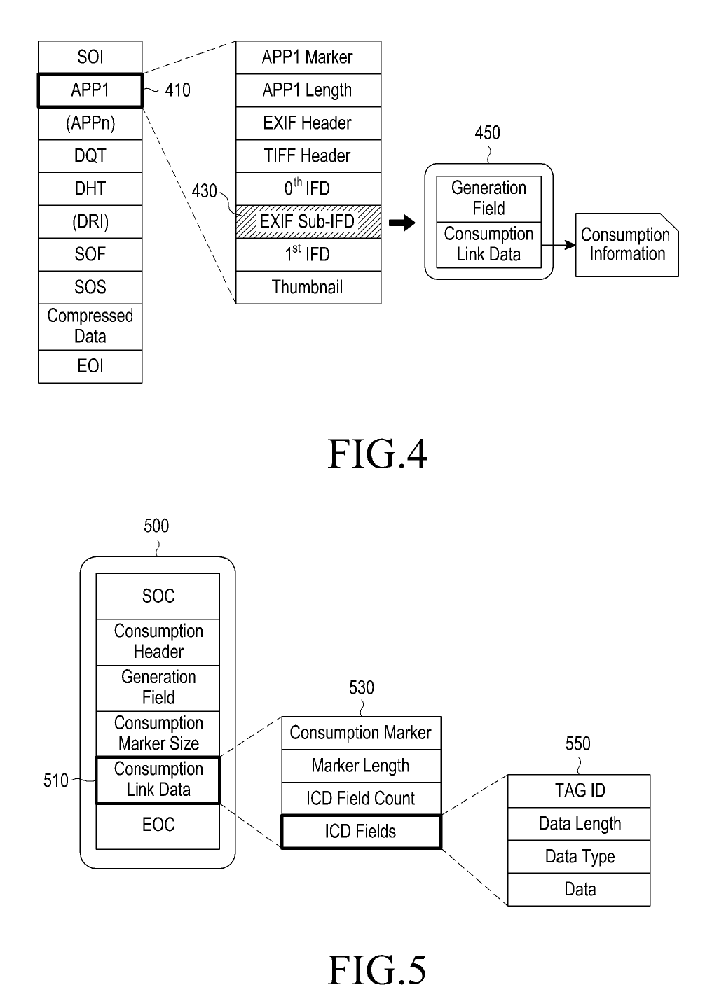

The obtainer 111 may obtain and collect consumption information of images for respective applications 117-1 to 117-N. The recorder 113 may record the obtained consumption information in a recording area to manage images. For example, the obtainer 111 may obtain and collect consumption information of images in a procedure as illustrated in FIG. 3. The recorder 113 may record the consumption information obtained by the obtainer 111 in a recording area to manage the image as illustrated in FIGS. 4 and 5.

Referring to FIGS. 2 to 5, a method, in which the obtainer 111 and the recorder 113 respectively obtain and collect consumption information of an image and record the obtained consumption information in a recording area to manage an image, will now be described in greater detail.

FIG. 3 is a flowchart illustrating an example method for obtaining and collecting consumption information of an image in the obtainer 111 included in the control unit 110, according to an example embodiment of the present disclosure.

Referring to FIG. 3, the obtainer 111 performs monitoring on images stored in the storage unit 170 in the terminal 100, in step 301. The obtainer 111 detects that an event of approaching an arbitrary image 115 has occurred through the input unit 151, in step 303.

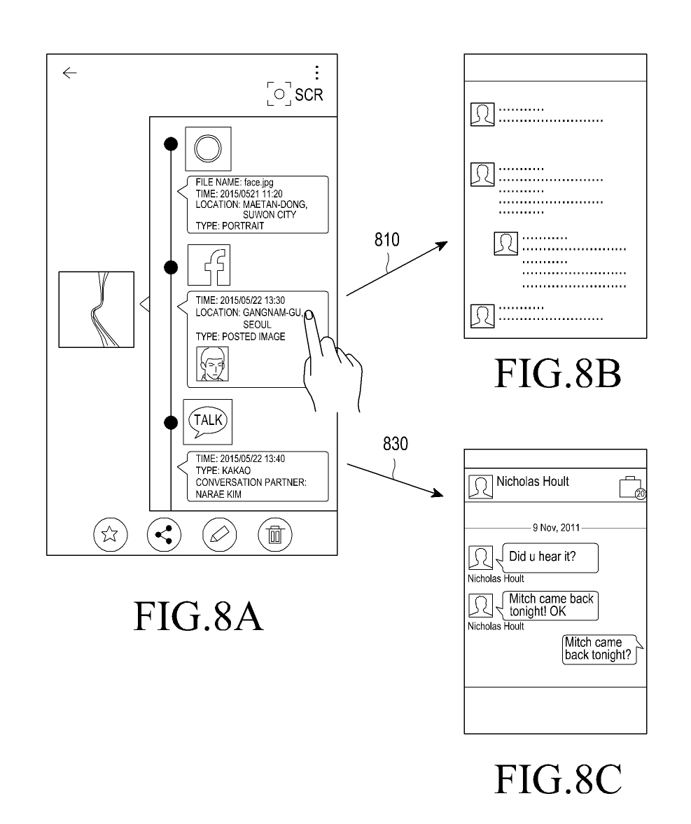

The obtainer 111 determines whether the image 115 has been consumed by at least one of the plurality of applications 117-1 to 117-N based on the detected approaching event, in step 305. If the image 115 has been consumed by at least one application, the obtainer 111 obtains information of the image 115 to check out the consumed image, in step 307. On the other hand, if the image 115 has not been consumed by at least one application, the process goes back to step 301. The obtainer 111 obtains information about an application that has consumed the image and determines the application that has consumed the image, in step 309, and obtains consumption information about consumption of the image 115 in the determined application, in step 311. The consumption information may include, for example, and without limitation, at least one of ID, name, icon image of the application that has consumed the image 115, information relating to time at which the image 115 has been consumed, information relating to a location at which the image 115 has been consumed, information relating to a method and type in which the image 115 has been consumed, information relating to a consuming object that has consumed the image 115, link information, and keyword information used together. The information about the consumption method and type may refer, for example, to information about in which method the user has consumed the content. In other words, the information about the consumption method and type may be information about whether arbitrary content is consumed by being sent in a message to another user, by being uploaded to a website, or by being posted on an SNS. For example, the information about the consumption method and type may be information to be indicated in a “type” part in a timeline as illustrated in in FIG. 8. Once consumption methods are categorized by using the consumption method and type, it may be used in choosing and viewing only images posted by the user on an SNS or only images sent with a messenger. The information about an object that has consumed the image may refer to information about an object if the user has allowed the object to consume the content. For example, if the content has been consumed in the form of being sent to another user, the information may be about who has received the content. In another example, if the content is uploaded to a website, the corresponding information may not be recorded because no object is specified. Furthermore, the information about an object that has consumed the image may be information to be indicated in a “conversation partner” part in the timeline illustrated in FIG. 8. The information about the object that has consumed the image may be used in choosing and viewing only images shared with a particular user or making an album with the images. The link information may refer to information that, when the user has consumed content, allows access and reenact the consumption act. For example, if the image is uploaded to a website, URL information of the website may be recorded (and the image may be accessed later with the recorded URL), and if the image is sent to a particular user through a messenger, command information to execute the messenger in the terminal may be recorded. The recorded command may be executed later to access a chat room in the messenger in which the image has been consumed. The link information may not be exposed to the user, but may be used when the user touches consumption information in the timeline to access the consumption act. The link information may be internally used for steps 810 and 830 in FIG. 8. The keyword information may refer to key pieces of information that may be additionally recorded when the user has consumed the content. For example, as for the keyword information, if an image is uploaded to a website, title information of the website (about what website it is) may be recorded, or if the image is sent in email, information about a title of the email may be recorded. Using the keyword information, comments on an image written when the image is posted on an SNS may be recorded. The keyword information is optional information, so if there is the keyword information, the keyword information may be provided to the user, or if there is no keyword information, the keyword information may be omitted.

The obtainer 111 composes the obtained consumption information into defined metadata, in step 313, and completes obtaining and collecting the consumption information, in step 315.

FIGS. 4 and 5 are diagrams illustrating examples of how the recorder 113 included in the control unit 110 records consumption information in a recording area to manage an image, according to example embodiments of the present disclosure. FIG. 4 illustrates an example of recording consumption information using Exchange Image File Format (EXIF) in the recorder 113, and FIG. 5 illustrates an example of recording consumption information using a new image format in the recorder 113.

Referring to FIG. 4, the recorder 113 may record consumption information using an existing area to record information in an image. For example, the existing area to record consumption information may be arranged as in FIG. 4. In FIG. 4, the recorder 113 may record the consumption information in an EXIF sub-image file directory (IFD) area 430 included in an APPl field 410. In this regard, the recorder 113 may record information about the terminal that has the image and a link 450 to the consumption information in the EXIF sub-IFD area 430. Consumption details included in the consumption information may be checked out by referring to the information about the link. The consumption details included in the consumption information may refer to details of the content actually consumed by each application. The link to the consumption information may refer to link information enabling access to the consumption information recorded out of an image area. For example, the link to the consumption information may be information indicating where the consumption information is recorded (i.e., information indicating a particular location in the terminal). In this regard, the information about the terminal that has the image and the link 450 to the consumption information may be what are recorded in the image (i.e., information to be sent to another terminal).

Referring to FIG. 5, the recorder 113 may record consumption information using a new area to record consumption information. For example, the new area to record consumption information may be arranged as in FIG. 5. In FIG. 5, the recorder 113 may record consumption information in a consumption link data field 510 included in an image area 500. The image area 500 may be what is recorded in the image (i.e., information to be sent to another terminal).

The consumption link data field 510 may include at least one consumption marker, and a consumption marker 530 may be generated and added every time the image is consumed. Accordingly, the recorder 113 may generate a single consumption marker 530 whenever receiving consumption information from the obtainer 111, and record information about a terminal that has the image and a link to the consumption information in an ICD field of the consumption marker 530. The consumption information connected through the link may be managed at an outside of the image, so if the image is delivered to and shared with another terminal, the consumption information may not be delivered. In other words, a consumption act corresponds to a consumption marker. The ICD field of the consumption marker 530 may include at least one piece of consumption information, and a piece of consumption information may correspond to a tag 550. For example, if a consumption act is delivered to John Doe, the following consumption information may be recorded in ICD fields as shown in Table 1. In this regard, delivering an image to John Doe in KakaoTalk® may correspond to a consumption marker.

TABLE 1
TAG1 (TAG ID = application ID, Data Length = 16, Data Type =
character string, Data = “com.kakao”)
TAG2 (TAG ID = application name, Data Length = 16, Data
Type = character string, Data = “KakaoTalk”)
TAG3 (TAG ID = icon image, Data Length = 512, Data Type = Image,
Data = [symbol] )
TAG4 (TAG ID = consumption time, Data Length = 16, Data Type =
date, Data = “20151001134000”)
TAG5 (TAG ID = consumption location, Data Length = 32, Data
Type = number, Data = GPS location information)
TAG6 (TAG ID = consumption object, Data Length = 16, Data
Type = character string, Data = John Doe)
TAG7 (TAG ID = link information, Data Length = 64, Data
Type = character string, Data = “com.kakao.Intent.x”)
TAG8 (TAG ID = keyword information, Data Length = 64, Data
Type = character string, Data = “Did u hear it?”)

In Table 1, the respective pieces of TAG information (TAG1 to TAG8) may be arranged sequentially and recorded in the ICD fields, and in this example, ICD Field Count=8. Furthermore, in the example, if the image delivered to John Doe is additionally posted on an SNS, a new consumption marker may be generated, and the image area 500 may include two consumption markers as in the following Table 2.

TABLE 2
1^{st} Consumption Marker: composed with information delivered to John
Doe in KakaoTalk ®
2^{nd} Consumption Marker: composed with information posted on an
SNS

In the example embodiment illustrated in FIG. 4 or 5, after the consumption information has been recorded in a recording area to manage an image, if the control unit 110 detects a request event for requesting an image through the input unit 151, it is determined whether consumption information is recorded in the recording area to manage the requested image. The control unit 110 may then output the image and consumption information through the output unit 153 if the consumption information is recorded in the recording area to manage the requested image. On the other hand, if the consumption information is not recorded in the recording area to manage the requested image, the control unit 100 may output only the image through the output unit 153.

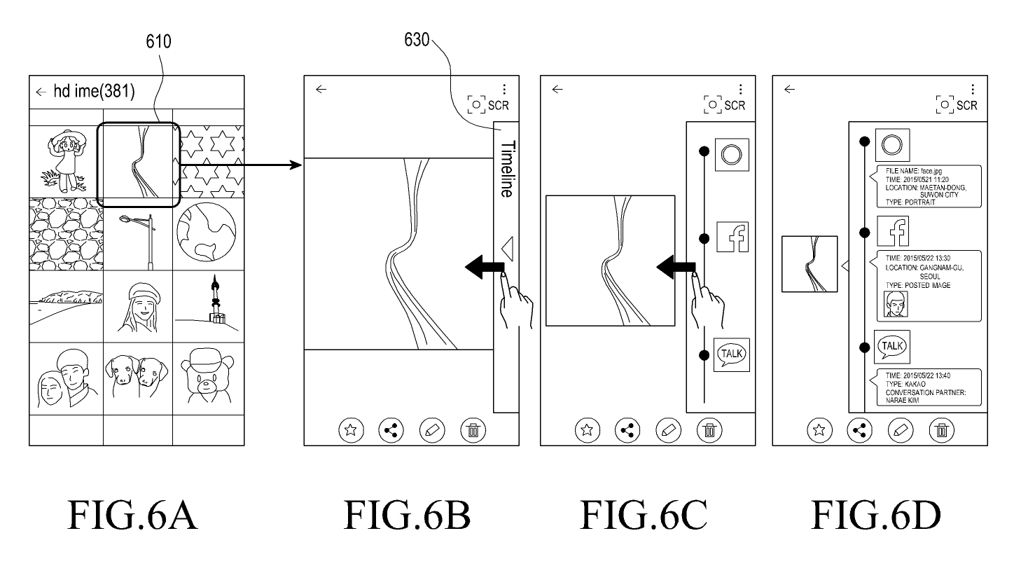

For example, the control unit 110 may have a layout that may represent an image and consumption information as illustrated in FIG. 6 and output the image and consumption information through the output unit 153.

FIGS. 6A, 6B, 6C and 6D are diagrams illustrating an example of outputting an image and consumption information in an output unit 153, according to an example embodiment of the present disclosure.

Referring to FIGS. 6A-6D, receiving a request event requesting a particular image 610 through the input unit 151 in FIG. 6A, the control unit 110 responds to the request event and controls the image 610 and a consumption layout 630 to be displayed through the output unit 153, the consumption layout 630 being displayed to the right of the area in which the image 610 is displayed, in FIG. 6B. The consumption layout 630 may have a resizable form, and consumption information of each application may be displayed in a time sequence based on a timeline as illustrated in FIG. 6C. The consumption information may be displayed not only in the time sequence but also according to the number of times the image 610 has been used in each application and user settings.

For example, the control unit 110 may set different sizes of the consumption layout 630 and different display grades of the consumption information displayed in the consumption layout 630, according to information about length of the consumption layout 630 being dragged through the input unit 151, in FIG. 6D. The consumption information of each application may be composed based on metadata, and consumption details included in the consumption information may differ by the depth of the metadata.

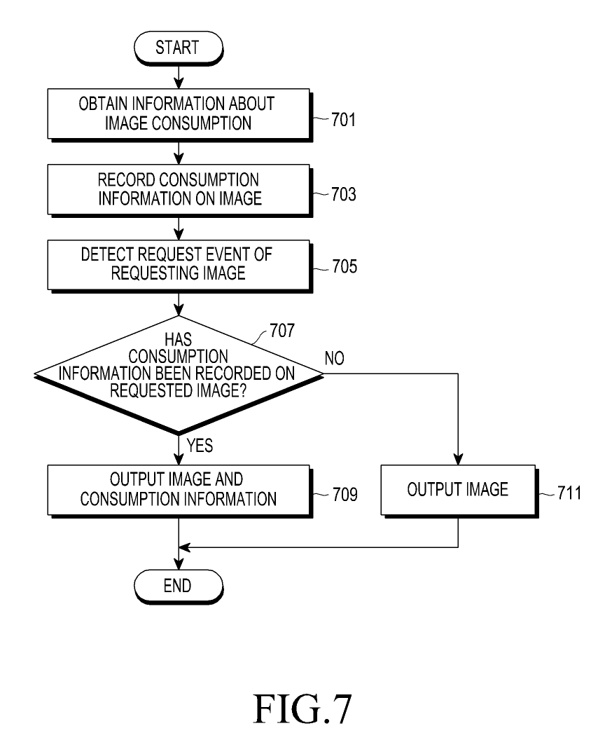

FIG. 7 is a flowchart illustrating an example method for providing consumption information about content in a terminal of a communication system, according to an example embodiment of the present disclosure.

Referring to FIG. 7, the terminal 100 obtains consumption information about an arbitrary image being used by at least one application, in step 701, as in the procedure illustrated in FIG. 3. The terminal 100 records the obtained consumption information in a recording area to manage the image in step 703, as illustrated in the example embodiment of FIGS. 4 and 5.

The terminal 100 then detects a request event requesting an image, in step 705, and determines whether consumption information is recorded in a recording area to manage the requested image, in step 707. If the consumption information is not recorded in the recording area to manage the requested image, the terminal 100 outputs the requested image through the output unit 153, in step 711. On the other hand, if the consumption information is recorded in the recording area to manage the requested image, the terminal 100 outputs the requested image and the consumption information recorded in the recording area to manage the requested image through the output unit 153, in step 709. In this regard, the terminal 100 may output the consumption information according to at least one of a time sequence, the number of times the image has been used by each application, and user settings as in the embodiment of FIG. 6.

Accordingly, the terminal 100 may output the consumption information on the requested image through the output unit 153, and consumption details of each application included in the output consumption information may be used as will be described below.

FIGS. 8A, 8B and 8C are diagrams illustrating an example of utilizing consumption details included in consumption information in a terminal 100, according to an example embodiment of the present disclosure.

Referring to FIG. 8A, if detecting an event to request consumption details included in consumption information, the terminal 100 may output a screen indicating the details about how a previous image was used in an application in response to the detected event. For example, if detecting an event to request consumption details corresponding to reference numeral 810, the terminal 100 may output details about how the image was used in the application corresponding to the reference numeral 810 on a screen as illustrated in FIG. 8B, in response to the detected event. Furthermore, if detecting an event to request consumption details corresponding to reference numeral 830, the terminal 100 may output details about how the image was used in the application corresponding to the reference numeral 830 on a screen as illustrated in FIG. 8C, in response to the detected event.

Accordingly, the terminal 100 may check out how the image was used by representing how the image was consumed in the past. In addition, if the terminal 100 deletes the image in association with the image and the past consumption details of the image, the past consumption details of the image may also be deleted at the same time.

In another example, the terminal 100 may automatically compose an album by extracting images that has been consumed more than certain threshold times, or classify images by categorizing them by consumption type. For example, the terminal 100 may classify images shared with a particular user or posted on a particular SNS and display the result. When it comes to taking pictures, in general, the user often takes a picture of similar scenes several times. In this regard, the terminal 100 may set an image that has been most frequently used by the user to a representative image for the similar images, and output the representative image when the user views pictures.

In another example, since information about a last terminal to which the image was delivered and the delivering method are recorded in the image, the terminal 100 may check out in which path the image was delivered and find the source of the image.

In yet another example, if a particular image is used in an SNS application, the terminal 100 may cooperate with a server for managing the SNS application to easily check out information relating to text created in the SNS while consuming the particular image (e.g., information about view count, comments, “like”, etc.) through the particular image without using the SNS application.

According to various example embodiments of the present disclosure, new usage experiences may be provided for the user by providing a collection and signature technology about consumption information of an image, managing image consumption methods in a trend that image use is on the rise, and enabling images to be used in more various ways than before.

Several example embodiments have thus been described, but it will be understood that various modifications can be made without departing the scope of the present disclosure. Thus, it will be apparent to those ordinary skilled in the art that the disclosure is not limited to the embodiments described, but can encompass not only the appended claims but their equivalents.

What is claimed is:

1. A method for providing content information in a communication system, the method comprising:
obtaining consumption information relating to consumption of content;
recording the consumption information in a recording area of the content; and
outputting the content and the consumption information if a request event to request the content is detected.

2. The method of claim 1, wherein the recording area comprises an EXchangeable Image File Format (EXIF) Image File Directory (IFD) area.

3. The method of claim 1, wherein the recording area comprises an area included in an image area in which an image is recorded.

4. The method of claim 3, wherein the recording area comprises a consumption link data field.

5. The method of claim 4, wherein the consumption link data field comprises at least one consumption marker generated each time the content is consumed, and a single consumption marker comprising information about a terminal that has the content and link information on the consumption information.

6. The method of claim 1, wherein outputting the content and the consumption information if a request event to request the content is detected comprises arranging and outputting consumption details included in the consumption information based on at least one of: a time sequence in which the content was used, the number of times the content was used in each application, and user settings.

7. The method of claim 1, wherein the consumption information comprises at least one of: ID, name, an icon image of an application that consumed the content, information relating to a time at which the content was consumed, information relating to a location at which the content was consumed, a method and type in which the content was consumed, information relating to a consuming object that consumed the content, link information, and keyword information.

8. The method of claim 1, wherein the consumption information relating to consumption of the content is obtained if an event of approaching the content is detected and if the content was consumed by an application.

9. The method of claim 8, wherein the consumption information comprises predetermined metadata.

10. The method of claim 1, wherein the content comprises at least one of: an image, audio, and video.

11. An apparatus configured to provide content information in a communication system, the apparatus comprising:
a controller comprising processing circuitry configured to obtain consumption information relating to consumption of content, to record the consumption information in a recording area of the content, and to output the content and the consumption information if a request event to request the content is detected; and
an output unit comprising output circuitry configured to output the content and the consumption information.

12. The apparatus of claim 11, wherein the recording area comprises an EXchangeable Image File Format (EXIF) Image File Directory (IFD) area.

13. The apparatus of claim 11, wherein the recording area comprises an area included in an image area in which an image is recorded.

14. The apparatus of claim 13, wherein the recording area comprises a consumption link data field.

15. The apparatus of claim 14, wherein the consumption link data field comprises at least one consumption marker generated each time the content is consumed, and a single consumption marker comprising information about a terminal that has the content and link information on the consumption information.

16. The apparatus of claim 11, wherein the controller is configured to arrange consumption details included in the consumption information based on at least one of: a time sequence in which the content was used, the number of times the content was used in each application, and user settings, and to output the arranged consumption details.

17. The apparatus of claim 11, wherein the consumption information comprises at least one of: ID, name, an icon image of an application that consumed the content, information relating to a time at which the content was consumed, information relating to a location at which the content was consumed, a method and type in which the content was consumed, information relating to a consuming object that consumed the content, link information, and keyword information.

18. The apparatus of claim 11, wherein the consumption information relating to consumption of the content is obtained if an event of approaching the content is detected and if the content was consumed by an application.

19. The apparatus of claim 18, wherein the consumption information comprises predetermined metadata.

20. The apparatus of claim 11, wherein the content comprises at least one of: an image, audio, and video.
